(19) United States
(12) Patent Application Publication
(10) Pub. No.: US 2009/0216607 A1
(43) Pub. Date: Aug. 27, 2009

(54) Method and Apparatus for Behavioral and Contextual Ad Targeting Based on User Calendar Data

(76) Inventor: Michael Bartholomew, Burbank, CA (US)

Correspondence Address: STATTLER - SUH PC, 60 SOUTH MARKET STREET, SUITE 480, SAN JOSE, CA, 95113, US

(21) Appl. No.: 12/035,319

(22) Filed: Feb. 21, 2008

(51) Int. Cl. G06Q 30/00

(52) U.S. Cl. 705/10; 705/14

(57) ABSTRACT

A method and apparatus are provided for behavioral and contextual ad targeting based on user calendar data. In one example, the method includes receiving user input including calendar data, storing the user input in a calendar database, performing targeting processing on the user input, generating a user profile based on the targeting processing, categorizing the user into one or more consumer segments based on the user profile, and writing identifiers of the one or more consumer segments to a cookie of the user, wherein an ad server may target ads against the one or more consumer segments that the ad server identifies via the identifiers.

### FIELD OF THE INVENTION

The present invention relates to online ad targeting. More particularly, the present invention relates to behavioral and contextual online ad targeting.

### BACKGROUND OF THE INVENTION

The Internet provides a mechanism for merchants to offer a vast amount of products and services to consumers. Internet portals provide users an entrance and guide into the vast resources of the Internet. Typically, an Internet portal provides a range of search, email, news, shopping, chat, maps, finance, entertainment, and other Internet services and content. Yahoo!® is an example of such an Internet portal.

When a user visits certain locations on the Internet (e.g., web sites), including an Internet portal, the user enters information in the form of online activity. This information may be recorded and analyzed to determine behavioral patterns and interests of the user. In turn, these behavioral patterns and interests may be used to target the user to provide a more meaningful and rich experience on the Internet, such as an Internet portal site. For example, if interests in certain products and services of the user are determined, advertisements, pertaining to those products and services, may be served to the user. A behavioral targeting system that serves advertisements benefits both the advertiser, who provides their message to a target audience, and a user that receives advertisements in areas of interest to the user.

Currently, Yahoo!® and many other major publishers charge advertisers a premium for ads which are behaviorally targeted to consumers. Examples of premium ads are ads which Yahoo!® shows to specific users who have demonstrated a behavior that Yahoo!® used to categorize those users into a set of predefined consumer segments within a degree of certainty. Traditionally, publishers create these behavioral segments by tracking users' browsing and searching behaviors.

Search engines have recently started using a hybrid of behavioral and contextual targeting. The hybrid involves combining the contextual matching of words on a page with the behavioral targeting of users' behaviors. Google®, for example, has extended its behavior targeting model by tracking users' interactions with its webmail services. They use their product Gmail® to collect data about their users. Gmail® provides a rich database of information by tracking the emails that users send and receive. For example, if a user receives an email about Plasma TVs, that user may receive an ad from Panasonic® about their new line of plasmas. Leaving public concern about privacy issues aside, Google® has created a way of delivering targeted ads to users which provides hefty revenue.

Both Yahoo!® and Google® currently use behavioral targeting to match ads to the context of sites across their networks. Unfortunately, conventional behavioral and contextual targeting has its limitations. For example, targeting users during their regular buying cycles is difficult or nonexistent.

### SUMMARY OF THE INVENTION

What is needed is an improved method having features for addressing the problems mentioned above and new features not yet discussed. Broadly speaking, the present invention fills these needs by providing a method and apparatus for behavioral and contextual ad targeting based on user calendar data. It should be appreciated that the present invention can be implemented in numerous ways, including as a method, a process, an apparatus, a system or a device. Inventive embodiments of the present invention are summarized below.

In one embodiment, a method of targeting ads for a user is provided. The method comprises receiving user input including calendar data, storing the user input in a calendar database, performing targeting processing on the user input, generating a user profile based on the targeting processing, categorizing the user into one or more consumer segments based on the user profile, and writing identifiers of the one or more consumer segments to a cookie of the user, wherein an ad server may target ads against the one or more consumer segments that the ad server identifies via the identifiers.

In another embodiment, an apparatus for targeting ads for a user is provided. The apparatus comprises a receiver device configured to receive user input including calendar data, wherein the apparatus is configured to store the user input in a calendar database. The apparatus also comprises a targeting processor configured to perform targeting processing on the user input, to generate a user profile based on the targeting processing, to categorize the user into one or more consumer segments based on the user profile, and to write identifiers of the one or more consumer segments to a cookie of the user, wherein an ad server may target ads against the one or more consumer segments that the ad server identifies via the identifiers.

In still another embodiment, a computer readable medium carrying one or more instructions for targeting ads for a user. The one or more instructions, when executed by one or more processors, cause the one or more processors to perform the steps of receiving user input including calendar data, storing the user input in a calendar database, performing targeting processing on the user input, generating a user profile based on the targeting processing, categorizing the user into one or more consumer segments based on the user profile, and writing identifiers of the one or more consumer segments to a cookie of the user, wherein an ad server may target ads against the one or more consumer segments that the ad server identifies via the identifiers.

The invention encompasses other embodiments configured as set forth above and with other features and alternatives.

### BRIEF DESCRIPTION OF THE DRAWINGS

The present invention will be readily understood by the following detailed description in conjunction with the accompanying drawings. To facilitate this description, like reference numerals designate like structural elements.

FIG. 1 is a block diagram of a system for behavioral and contextual ad targeting, in accordance with an embodiment of the present invention;

FIG. 2 is a schematic diagram of a system for behavioral and contextual ad targeting, in accordance with an embodiment of the present invention;

FIG. 3 is a schematic diagram of contextual ad targeting using an online calendar service, in accordance with an embodiment of the present invention;

FIG. 4 is a schematic diagram of behavioral ad targeting using an online calendar service, in accordance with an embodiment of the present invention;

FIG. 5 is a schematic diagram of contextual (geographic) and behavioral ad targeting using an online calendar service, in accordance with an embodiment of the present invention; and

FIG. 6 is a flowchart of a method of behavioral and contextual ad targeting, in accordance with an embodiment of the present invention.

### DETAILED DESCRIPTION OF THE INVENTION

An invention is disclosed for a method and apparatus for behavioral and contextual ad targeting based on user calendar data. Numerous specific details are set forth in order to provide a thorough understanding of the present invention. It will be understood, however, to one skilled in the art, that the present invention may be practiced with other specific details.

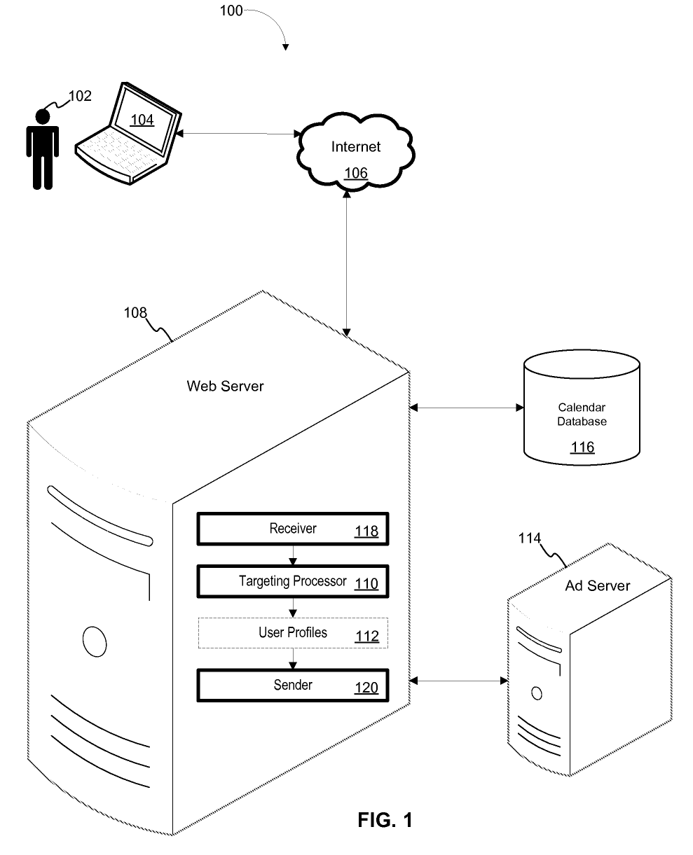

FIG. 1 is a block diagram of a system 100 for behavioral and contextual ad targeting, in accordance with an embodiment of the present invention. In this example, the system 100 includes, among other things, a user computer 104 for a user 102. The user computer 104 is coupled to the Internet 106, which is coupled to a web server 108, which is coupled to an ad server 114 and a calendar database 116. An online calendar service controls the calendar database 116. The online calendar service may reside within the web server 108 or may be located outside of the web server 108. In an alternative embodiment, the web server 108, the ad server 114 and the calendar database 116 are part of one apparatus.

The web server 108 receives via the receiver device 118. The web server may receive information based on user behavior, such as events, and the context of such user behavior. The context of such an event may be placement of the event within an online calendar. Web server 108 includes a targeting processor device 110 that performs behavior and contextual processing for the system 100. The targeting processor device 110 receives user behavioral and contextual information from the Internet 106 and the calendar database device 116. In an alternative embodiment, the calendar database device 116 may instead be a messenger database, an autos database, a maps database or any other type of database configured to store user input.

The targeting processor device 110 generates user profiles 112 based on the behavioral and contextual information. A user profile 112 includes a user score for a particular ad type. A user score indicates a likelihood of a particular ad type appealing to the user. Examples of particular ad types include auto ads, oral hygiene ads, legal services ads, etc. One user profile may include several different user scores for several different ad categories. The web server 108 may send information to external machines, such as the ad server 114, via the sender device 120.

Preferably, the ad server 114 does not receive data feeds. Rather, the ad server 114 may be configured to match the highest revenue earning ad it can serve for a given user and placement. The ad server 114 does this by quickly reading the user's cookie and cross-checking currently queued ad orders. If the ad server 114 identifies an ad order requiring behaviorally targeted ads that match the consumer segment identified in the user's cookie, then the ad server 114 serves those ads to that user. As a result, the system 100 serves customized ads to the user computer 104.

A device is hardware, software or a combination thereof. Each device is configured to carry out one or more steps for the method of serving ads using behavioral and contextual targeting. For explanatory purposes, FIG. 1 shows the system 100 as having a web server 108 with a targeting processor device 110 located therein. However, the targeting processor 110 may alternatively be located on another machine besides the web server 108.

The system 100 uses a hybrid of behavioral and contextual targeting. The system 100 may have access to extensive online services that have the opportunity to use a substantially large data set when defining and filling consumer segments. A consumer segment is a group of consumers who are eligible to receive a particular ad type, for example, auto ads, legal services ads, snowboard ads or oral hygiene ads, among many others. The system 100 focuses on the use of an online calendar service, such as Yahoo!® Calendar. However, the system 100 may use similar data mining and ad targeting technology across a host of other products, including but no limited to Y!® Messenger, Y!® Autos and Y!® Maps.

Many online users rely on an online calendar service, such as Yahoo!® Calendar at http://calendar.yahoo.com, to enter dates and other reminders. It turns out that Yahoo!® also currently owns the largest social-calendaring site on the web in upcoming.org. The system 100 could use both of these sites to gather users' data pertaining to what, when, and where the users will be doing things. The system 100 uses this data to target ads behaviorally and contextually. Data from an online calendar allows the system 100 to target users during their regular buying cycles.

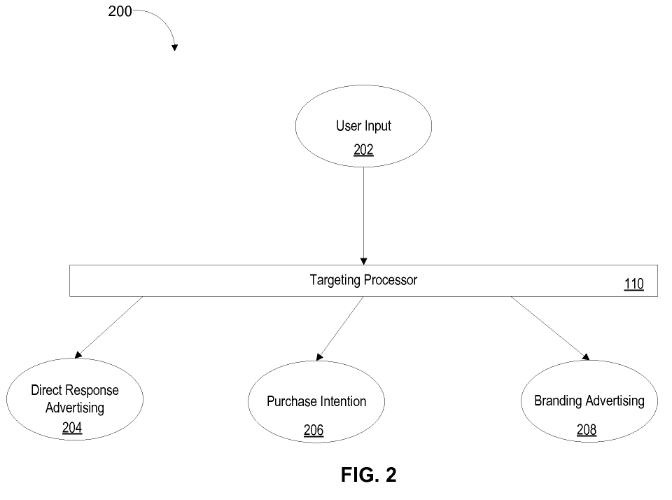

FIG. 2 is a schematic diagram of a system 200 for behavioral and contextual ad targeting, in accordance with an embodiment of the present invention. Generally, the system 200 profiles interests and behavior of Internet users based on the user's online activities. The system 200 also profiles the context of such interests and behavior.

The targeting processor device 110 captures user input 202. In one embodiment, user input comprises one or more “events.” An event is a type of action initiated by the user (e.g., user clicks on a banner advertisement). The targeting processor device 110 generates a plurality of user profiles specific for an ad target objective. A behavioral and contextual user profile predicts user success for a particular target objective. For example, a behavioral and contextual user profile may predict a user's propensity to respond to a direct marketing advertisement campaign. In one embodiment, the user behavioral and contextual profile is expressed in a per category basis. For example, the user profile includes a user score indicating that the user is a good candidate for the objective regarding the topic “finance”, and may include a user score indicating that the user is a poor candidate for the objective regarding the topic “music”.

The targeting processor device 110 generates behavioral and contextual user profiles for various target objectives. In the embodiment shown in FIG. 2, the system 200 outputs user behavioral and contextual profiles for direct response advertising 204, purchase intention activities 206, and brand awareness advertising 208. The targeting processor device 110 generates behavioral and contextual profiles primarily for marketing objectives.

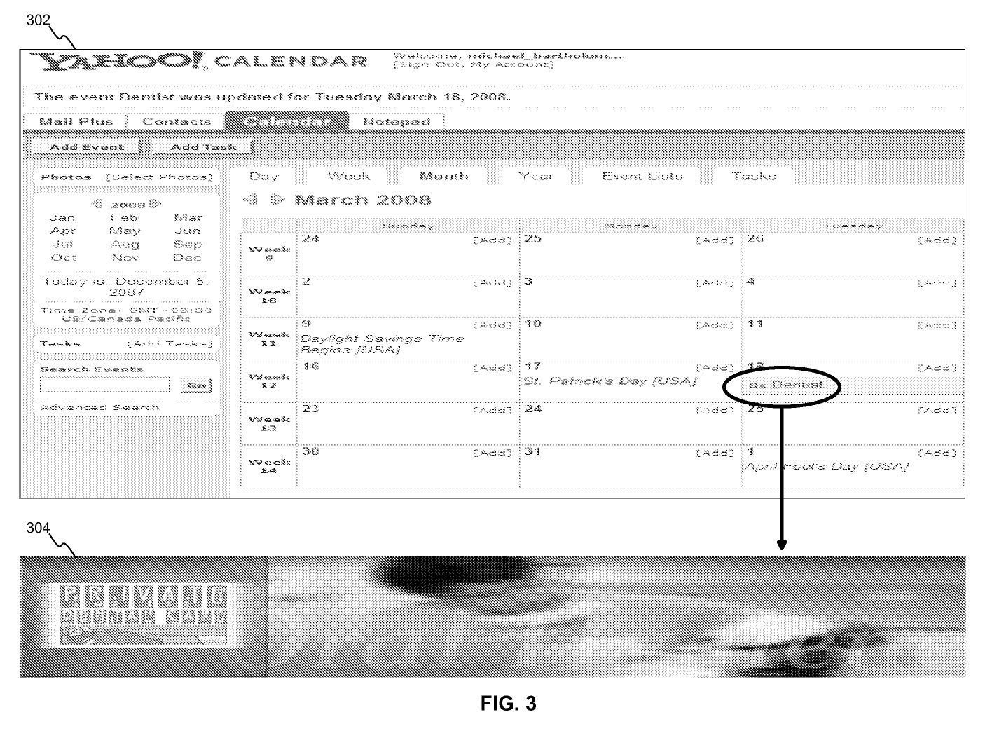

FIG. 3 is a schematic diagram of contextual ad targeting using an online calendar service, in accordance with an embodiment of the present invention. In this example, the system has ‘Dentist’ on the user's online calendar 302, dated Mar. 16, 2008. The system processes this data and may respond by showing user ads relating to oral hygiene before and after the user's appointment date. For example, the system may show the oral hygiene ad 304 the week before and the week after the user's appointment date.

This example is contextual targeting because the dentist appointment in the context of the calendar is important. The appointment date indicates the “when”. The fact that the appointment is a dentist appointment indicates the “what”. The system can determine the “where” of an activity to the designated marketing area (DMA) level by analyzing the user's IP address.

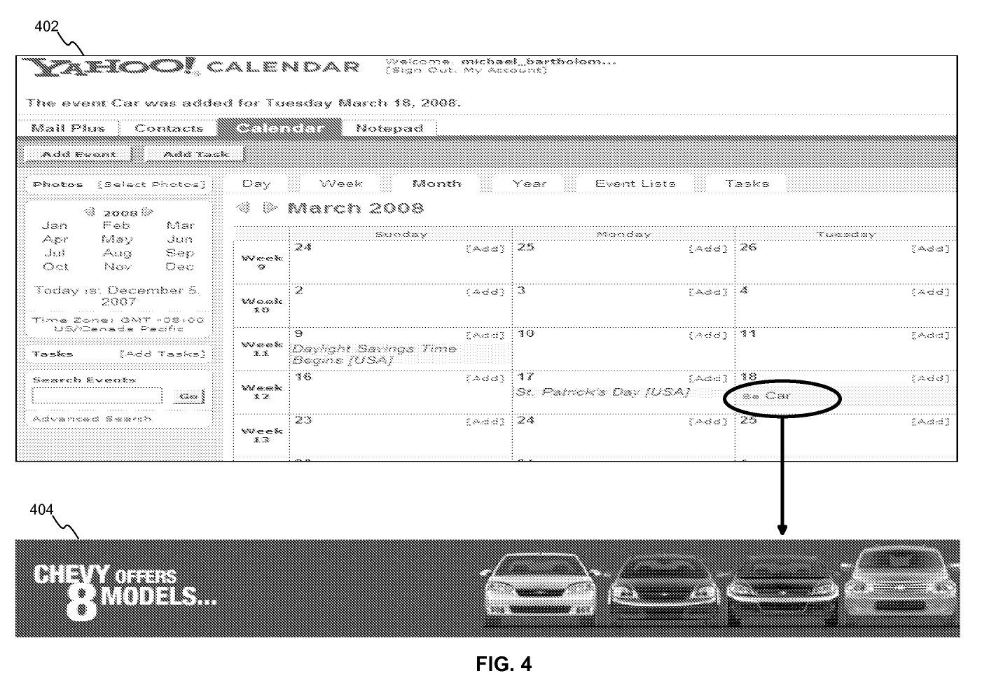

FIG. 4 is a schematic diagram of behavioral ad targeting using an online calendar service, in accordance with an embodiment of the present invention. In this example, the system has ‘Car’ on the user's online calendar 402, dated Mar. 18, 2008. The system processes this data and may respond by placing the user in the ‘Car Buying’ behavioral targeting category and showing car ads some time around the noted date. For example, the system may show the car ad 404 in the month of March 2008.

This example is behavioral targeting because the input of the word “car” on March 18^{th} does not necessarily indicate a particular appointment or something similar, but rather indicates that the user may doing something loosely related to cars on March 18th.

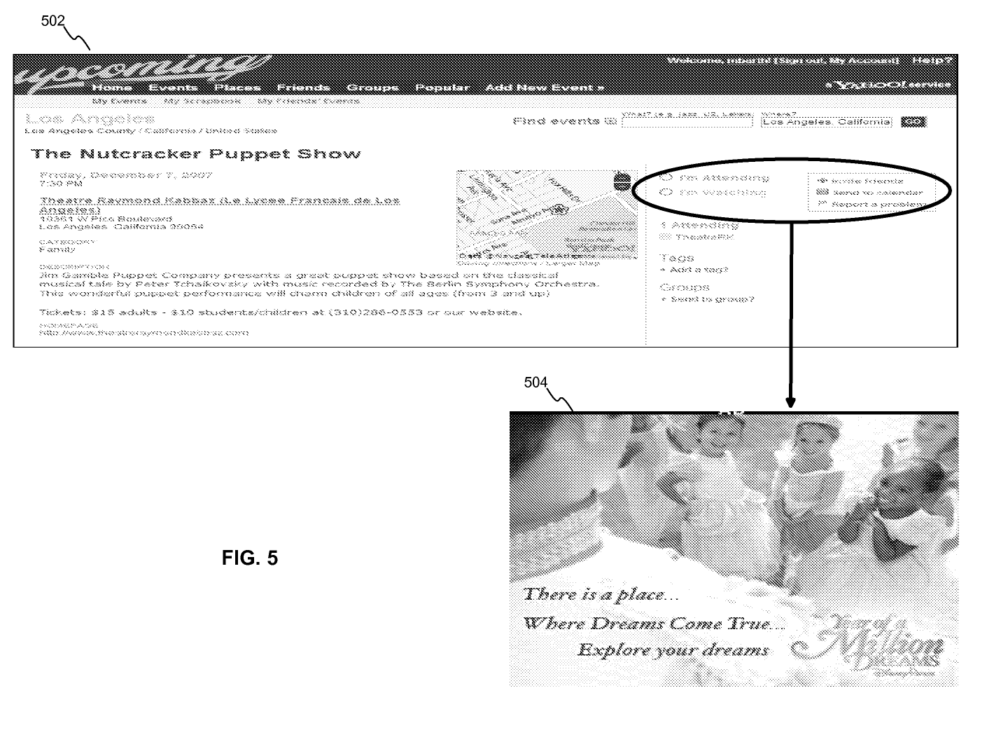

FIG. 5 is a schematic diagram of contextual (geographic) and behavioral ad targeting using an online calendar service, in accordance with an embodiment of the present invention. In this example, the system receives into the online calendar 502 a northern California based IP address from the user. The online calendar 502 is configured to receive “I'm Attending” or “Send to Calendar” for the Nutcracker in Los Angeles on Dec. 7, 2007. The system processes this data and may respond by showing ads for family vacations near the noted date. For example, the system may show the family vacation ad 504 in the months of November and December.

This example is contextual and behavioral targeting because of the mix of the user information at hand. This example shows where the system has the “what”, the “where” and the “when” available for targeted processing. The “what” is the Nutcracker Puppet Show. The “where” is 10361 West Pico Boulevard. The “when” is Dec. 7, 2007. The system is also configured to receive information on whether then user is attending or watching the event.

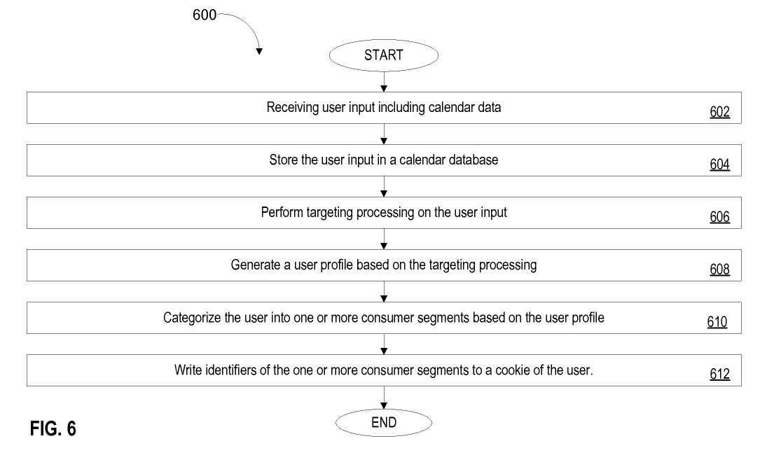

FIG. 6 is a flowchart of a method 600 of behavioral and contextual ad targeting, in accordance with an embodiment of the present invention. The method 600 starts in step 602 where the system receives user input, including calendar data, from a user computer. The web server 108 of FIG. 1 may be configured to carry out this receiving of user input from the user computer. Next, in step 604, the system stores the user input in a calendar database. The web server 108 of FIG. 1 may be configured to carry out this storing of user input into the calendar database.

The method 600 then proceeds to step 606 where the system performs targeting processing on the user input from the calendar database. The targeting processor device 110 of FIG. 1 may be configured to carry out this targeting processing. Then, in step 608, the system generates a user profile based on the targeting processing. The user profile may be an assessment on the “what”, “when” and “where” of a particular calendar entry. A user score in the user profile indicates a likelihood of a particular ad type appealing to the user. Examples of particular ad types include auto ads, oral hygiene ads, legal services ads, etc. One user profile may contain several different user scores for several different ad categories. The targeting processor device 110 of FIG. 1 may be configured to carry out this generating of a user profile. The method 600 moves to step 610 where the system categorizes the user into one or more consumer segments based on the user profile. The targeting processor device 110 of FIG. 1 may be configured to carry out this categorizing of the user. The method 600 then moves to step 612 where the system writes identifiers of the one or more consumer segments to a cookie of the user. The targeting processor device 110 of FIG. 1 may be configured to carry out this writing of the consumer segments to the user's cookie via the web server 108. The method 600 is then at an end. The ad server 114 may then serve targeted ads against the consumer segments identified in the user's cookie. Accordingly, even if the user is off-network, advertisers can target users as long as they are using the ad server at hand.

For explanatory purposes, the method 600 involves using a calendar database. However, the invention is no so limited. A method for serving ads using behavioral and contextual targeting may involve using another type of database, such as a messenger database, an autos database, a maps database or any other type of database configured to store user input.

### Computer Readable Medium Implementation

Portions of the present invention may be conveniently implemented using a conventional general purpose or a specialized digital computer or microprocessor programmed according to the teachings of the present disclosure, as will be apparent to those skilled in the computer art.

Appropriate software coding can readily be prepared by skilled programmers based on the teachings of the present disclosure, as will be apparent to those skilled in the software art. The invention may also be implemented by the preparation of application-specific integrated circuits or by interconnecting an appropriate network of conventional component circuits, as will be readily apparent to those skilled in the art.

The present invention includes a computer program product which is a storage medium (media) having instructions stored thereon/in which can be used to control, or cause, a computer to perform any of the processes of the present invention. The storage medium can include, but is not limited to, any type of disk including floppy disks, mini disks (MD's), optical disks, DVDs, CD-ROMs, micro-drives, and magneto-optical disks, ROMs, RAMs, EPROMs, EEPROMs, DRAMs, VRAMs, flash memory devices (including flash cards), magnetic or optical cards, nanosystems (including molecular memory ICs), RAID devices, remote data storage/archive/warehousing, or any type of media or device suitable for storing instructions and/or data.

Stored on any one of the computer readable medium (media), the present invention includes software for controlling both the hardware of the general purpose/specialized computer or microprocessor, and for enabling the computer or microprocessor to interact with a human user or other mechanism utilizing the results of the present invention. Such software may include, but is not limited to, device drivers, operating systems, and user applications. Ultimately, such computer readable media further includes software for performing the present invention, as described above.

Included in the programming (software) of the general/specialized computer or microprocessor are software modules for implementing the teachings of the present invention, including but not limited to receiving user input including calendar data, storing the user input in a calendar database, performing targeting processing on the user input, generating a user profile based on the targeting processing, categorizing the user into one or more consumer segments based on the user profile, and writing identifiers of the one or more consumer segments to a cookie of the user, wherein an ad server may target ads against the one or more consumer segments that the ad server identifies via the identifiers, according to processes of the present invention.

### Advantages

The present invention uses behavioral and contextual targeting to match ads to appropriate users. Using user input from an online calendar service, the system of the present invention is, among other things, capable of targeting users during their regular buying cycles.

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense.

What is claimed is:

1. A method of targeting ads for a user, the method comprising:
receiving user input including calendar data;
storing the user input in a calendar database;
performing targeting processing on the user input;
generating a user profile based on the targeting processing;
categorizing the user into one or more consumer segments based on the user profile; and
writing identifiers of the one or more consumer segments to a cookie of the user, wherein an ad server may target ads against the one or more consumer segments that the ad server identifies via the identifiers.

2. The method of claim 1, wherein the receiving calendar data comprises receiving calendar data from a user computer, wherein the calendar data is user input.

3. The method of claim 1, wherein an online calendar service controls the calendar database.

4. The method of claim 1, wherein the performing targeting processing comprises performing behavioral and contextual processing on the calendar data.

5. The method of claim 4, wherein the performing targeting processing further comprises accessing extensive online services that use a substantially large data set when defining and filling consumer segments.

6. The method of claim 1, wherein the performing targeting processing on the calendar data comprises gathering data pertaining to at least one of:
what event the user may be doing;
when the event is; and
where the event is.

7. The method of claim 1, wherein the generating the user profile comprises generating at least one user score for at least one ad category, wherein each user score indicates a likelihood of a particular ad type appealing to the user.

8. The method of claim 1, wherein the user input further includes at least one event, wherein an event is a type of action initiated by the user.

9. The method of claim 1, wherein the performing targeting processing on the user input comprises targeting the user for ads based on the user's regular buying cycles.

10. The method of claim 7, wherein categorizing the user into the one or more consumer segments comprises assigning a user score to each of the one or more consumer segments.

11. An apparatus for targeting ads for a user, the apparatus comprising:
a receiver device configured to receive user input including calendar data, wherein the apparatus is configured to store the user input in a calendar database;
a targeting processor configured to perform targeting processing on the user input, to generate a user profile based on the targeting processing, to categorize the user into one or more consumer segments based on the user profile, and to write identifiers of the one or more consumer segments to a cookie of the user, wherein an ad server may target ads against the one or more consumer segments that the ad server identifies via the identifiers.

12. The apparatus of claim 11, wherein the receiver device is further configured to receive calendar data from a user computer, wherein the calendar data is user input.

13. The apparatus of claim 11, wherein an online calendar service controls the calendar database.

14. The apparatus of claim 11, wherein the targeting processor is further configured to perform behavioral and contextual processing on the calendar data.

15. The apparatus of claim 14, wherein the targeting processor device is further configured to have access to extensive online services that use a substantially large data set when defining and filling consumer segments.

16. The apparatus of claim 11, wherein the targeting processor device is further configured to gather data pertaining to at least one of:
what event the user may be doing;
when the event is; and
where the event is.

17. The apparatus of claim 11, wherein the targeting processor is further configured to generate at least one user score for at least one ad category, wherein each user score indicates a likelihood of a particular ad type appealing to the user.

18. The apparatus of claim 11, wherein the user input further includes at least one event, wherein an event is a type of action initiated by the user.

19. The apparatus of claim 11, wherein the targeting processor device is further configured to target the user for ads based on the user's regular buying cycles.

20. The apparatus of claim 17, wherein the targeting processor is further configured to assign a user score to each of the one or more consumer segments.

21. The apparatus of claim 11, wherein the apparatus is a web server.

22. A computer readable medium carrying one or more instructions for targeting ads for a user, wherein the one or more instructions, when executed by one or more processors, cause the one or more processors to perform the steps of:
receiving user input including calendar data;
storing the user input in a calendar database;
performing targeting processing on the user input;
generating a user profile based on the targeting processing;
categorizing the user into one or more consumer segments based on the user profile; and
writing identifiers of the one or more consumer segments to a cookie of the user, wherein an ad server may target ads against the one or more consumer segments that the ad server identifies via the identifiers.
